(19) United States
(12) Patent Application Publication
(10) Pub. No.: US 2004/0209982 A1
(43) Pub. Date: Oct. 21, 2004

(54) Foams expanding in a fire

(76) Inventor: Heinrich Horacek, Linz (AT)

Correspondence Address: WENDEROTH, LIND & PONACK, L.L.P., 2033 K STREET N. W., SUITE 800, WASHINGTON, DC, 20006-1021, US

(21) Appl. No.: 10/823,624

(22) Filed: Apr. 14, 2004

(30) Foreign Application Priority Data
Apr. 14, 2003 (AT) A 567/2003

(51) Int. Cl. C08K 5/49; C08K 5/05; C08K 3/32

(52) U.S. Cl. 524/115; 523/177; 524/417; 524/386

(57) ABSTRACT

Foams expanding in a fire and based on styrene/butadiene, polyvinyl alcohol, polyurethane or neoprene, which contain a combination of phosphoric acid compound, polyalcohol and polyamide as an intumescent component.

The invention relates to flexible foams which are applied from a one-component or two-component spray can, gun or cartridge and which expand a second time in a fire.

The prior art discloses foams which contain small amounts of flame retardants which are intumescent, i.e. expand under heat and the action of fire.

Thus, for example, U.S. Pat. No. 3,574,644 or GB 2 168 706 describe flexible polyurethane foams which contain expandable graphite as a flame retardant. EP 1 127 908 furthermore discloses rigid polyurethane foams which likewise contain, inter alia, expandable graphite as an intumescent component.

In all these Applications, the addition of the intumescent compound results in an improvement in the fire behavior, but no measurable second expansion takes place.

Accordingly, it was an object of the present invention to provide flexible foams which, after they have been applied from a one-component or two-component spray can, gun or cartridge, expand a second time in a fire and thus form a hot gas seal.

Unexpectedly, it was possible to achieve this object by using a combination of phosphoric acid compound, polyalcohol and polyamides as the intumescent component.

The present invention accordingly relates to flexible foams expanding in a fire and based on styrene/butadiene, polyvinyl alcohol, polyurethane or neoprene, wherein said foams contain, as an intumescent component, a combination of phosphoric acid compound, polyalcohol and polyamides.

According to the invention, flexible foams based on styrene/butadiene, polyvinyl alcohol, polyurethane or neoprene are used.

The styrene/butadiene foams, polyvinyl alcohol foams and neoprene foams are water-based foams which are applied from one-component spray cans, guns or cartridges.

Polyurethane foams on the other hand are applied from two-component spray cans, guns or cartridges, in which the polyol component and the polyisocyanate component are present separately up to application, so as to inhibit reaction.

Suitable polyurethane foams are those which contain, as polyol component (A), a polyol from the group consisting of polyethylene glycol, polypropylene glycols, polypropylene glycols having ethylene oxide terminal groups, polyesterpolyols, polybutadienes having OH terminal groups, such as, for example, Poly Bd from elf atochem, or halogenated polyetherpolyols, such as, for example, Ixol B251 MI25 from Solvay, FOX-O-Pol VD280S from Resine Chemie, phosphoric ester-based polyols, such as Desmophen 4090N from Bayer, reaction products of 1 mol of phosphoric acid or phosphorus oxychloride, 2 mol of diols and 1 mol of dialkylamine, such as, for example, 2 mol of ethylene glycol and 1 mol of dimethylamine, and, as polyisocyanate component (B), polyisocyanates obtained from diisocyanates, such as, for example, methylenediphenyl diisocyanates (MDI) in the form of pure MDI or crude MDI, toluene diisocyanates (TDI), modified MDIs and TDIs, prepolymers of MDI and TDI, aliphatic isocyanates, such as, for example, 4,4′-diisocyanatodicyclohexylmethane, isophorone diisocyanate, hexamethylene diisocyanate, 2,2,4(2,4,4)-trimethylhexamethylene diisocyanate, hydrogenated toluene diisocyanate, dimeryl diisocyanate, lysine diisocyanate, trans-1,4-cyclohexane diisocyanate, 1,4-bisisocyanatomethylcyclohexane, benzenedisulfonyl isocyanate, dibenzoyl isocyanate, dihexylane [sic] diisocyanate, 3,3′-dimethyl-4,4′-diisocyanatodicyclohexylmethane, tetramethylene diisocyanate, 2-methylpentamethylene diisocyanate, xylylene diisocyanate, etc.

The ratio of component A to component B is preferably from 100:30 to 100:80.

According to the invention, the foams contain, as the intumescent component, a combination of phosphoric acid compound, polyalcohol and polyamide. A suitable phosphoric acid compound is ammonium polyphosphate, melamine phosphate, ethylenediamine phosphate, ammonium dihydrogen phosphate, aluminum orthophosphate, piperazine phosphate, guanidine phosphate, phosphoric ester polyols or urea phosphate. Suitable polyalcohols are pentaerythritol, dipentaerythritol, polyethylene glycol and phosphoric ester-based polyols.

Polyamides used are melamine, trihydrazinotriazine and dicyanodiamide. The individual compounds can be added in an amount of in each case 5-50% by weight, preferably of in each case 10-40% by weight, but in total not more than 75% by weight, preferably not more than 65% by weight.

In the case of the polyurethane foams, the phosphoric acid compound may be a constituent of the polyol component (A), in that polyols based on phosphoric esters are used.

The intumescent component is mixed with the starting materials of the foams and then filled into an appropriate one-component or two-component spray can, gun or cartridge. In the case of the polyurethane foams, the intumescent component is mixed with the polyol component (A).

Suitable one-component spray cans, guns or cartridges which are used for the water-based foams are those which apply the foam either by means of a propellant or with a mechanical aid, for example with a piston. For the polyurethane foams, 2-component cartridges, spray cans or guns having static mixers are used.

Optionally, customary assistants and additives, such as, for example, emulsifiers, foam stabilizers, drying agents, colored pigments, catalysts, solvents, etc., can also be added to the foams according to the invention.

The foams according to the invention are then introduced directly on site into the areas to be sealed and foam there to give the desired fire barrier. After emerging from the can, gun or cartridge used, the foams according to the invention have a density of from 25 to 550 g/l.

In a fire, the foams according to the invention expand a second time, the 2nd expansion factor (EF) being from 1.5 to 15.

Owing to this second expansion, the foams according to the invention are outstandingly suitable as a hot gas seal or as a heat-insulating soft barrier.

In addition, the subsequently expanding foams according to the invention achieve a substantially longer fire resistance time than conventional foams.

### EXAMPLE 1

### Styrene/butadiene Foam

For the preparation of a styrene/butadiene foam, the following starting materials were mixed:

| Parts | Starting materials |
|---|---|
| 180 | Styrene/butadiene (Styrofan D422, from BASF) |
| 6 | Emulsifier (Rewopol B 1003, from Degussa) |
| 0.5 | Silicone oil AK 350 (from Wacker) |
| 80 | Ammonium polyphosphate (Exolit AP 422; from |
| | Clariant) |
| 40 | Melamine (from Agrolinz Melamin) |
| 40 | Dipentaerythritol (from Perstorp) |
| Total 346.5 parts | |

300 parts of this mixture were filled with 100 parts of Frigen 12 (difluorodichloromethane) as a propellant into a pressurized can having a valve and, after leaving the can, gave a foam having a density of 80 g/l.

### EXAMPLE 2

### Polyurethane Foam

For the preparation of a polyurethane foam, the following starting materials were mixed:

| | |
|---|---|
| Parts | Starting materials |

Polyol component (A):

| | |
|---|---|
| 35.8 | Melamine (from Agrolinz Melamin) |
| 37.3 | Polyethylene glycol (Pluriol E 600, from |
| | BASF) |
| 21.6 | Phosphoric ester-based polyol (Desmophen |
| | 4090N, from Bayer) |
| 4.7 | Zeolite paste (from Bayer) |
| 0.6 | Foam stabilizer (Tegostab KS 6, from |
| | Goldschmidt) |
| 3 | Red pigment (Bayferrox 140, from Bayer) |
| 0.2 | Dibutyltin laurate DBTL (from Bayer) |

Component (B)

| | |
|---|---|
| 45 | Methylenediphenyl diisocyanate (Caradate 30; |
| | ICI) |
| 148.2 | |

100 g of A component and 43.6 g of B component were filled separately into a gun and, after leaving the static mixer, gave a foam having a density of 500 g/l.

### EXAMPLE 3

### Polyurethane Foam

For the preparation of a polyurethane foam, the following starting materials were mixed:

| | |
|---|---|
| Parts | Starting materials |

Polyol component (A)

| | |
|---|---|
| 35.8 | Melamine (from Agrolinz Melamin) |
| 37.3 | Polyethylene glycol (Pluriol E 600, from |
| | BASF) |
| 21.6 | Phosphoric ester-based polyol (Desmophen |
| | 4090N, from Bayer) |
| 2.0 | Water |
| 0.6 | Foam stabilizer (Tegostab KS 6, from |
| | Goldschmidt) |
| 3 | Red pigment (Bayferrox 140, from Bayer) |
| 0.2 | Dibutyltin dilaurate DBTL (from Bayer) |

Polyisocyanate component (B)

| | |
|---|---|
| 63.5 | Caradate 30 ICI |
| 164 | |

From a 2-component cartridge (A:B=100:63.2), a foam having a density of 30 g/l was obtained.

### EXAMPLE 4

### Neoprene Foam

For the preparation of a neoprene foam, the following starting materials were mixed:

| Parts | Starting materials |
|---|---|
| 180 | Neoprene rubber (Aquastik 1120, from DuPont) |
| 6 | Emulsifier (Rewopol B 1003, from Degussa) |
| 0.5 | Silicone oil AK 350 (from Wacker) |
| 150 | Dicyanodiamide/ammonium polyphosphate/ di- |
| | pentaerythritol (1:2:1) |
| Total 336.5 parts | |

300 parts of this mixture were filled with 100 parts of dimethyl ether/isobutane=1/1 into a pressurized can having a valve. A foam having a density of 100 g/l was obtained.

### EXAMPLE 5

### Polyvinyl Alcohol Foam

For the preparation of a polyvinyl alcohol foam, the following starting materials were mixed:

| Parts | Starting materials |
|---|---|
| 30 | Polyvinyl alcohol (MW = 14 000) |
| 5 | Glycerol |
| 190 | Water |
| 5 | Sodium dibromostearate |
| 40 | Ammonium polyphosphate |
| 40 | Trishydrazinotriazine |
| 40 | Pentaerythritol (from Perstorp) |
| Total 350 parts | |

330 parts of this mixture were filled with 100 parts of dimethyl ether/isobutane=1/1 into a pressurized can having a valve. A foam having a density of 150 g/l was obtained.

### EXAMPLE 6

For the determination of the fire resistance time, the foams from examples 1-5, and 3 conventional foams (V1: 1-component polyurethane (Intumex FS1), V2: 2-component polyurethane (Intumex FS2), V3: 2-component polyurethane (CP620, from Hilti)) were introduced into a joint with a ratio of joint depth to joint width of 10.

The 2nd expansion factor (EF) and the fire resistance time were determined.

| | | | Fire |
|---|---|---|---|
| | Density | | resistance |
| Foams | (g/l) | 2nd EF | time (min) |
| V1: 1-component polyurethane | 45 | 0 | 120 |
| V2: 2-component polyurethane | 50 | 0 | 130 |
| V3: 2-component polyurethane | 200 | 0 | 120 |
| Example 1 | 80 | 10 | 150 |
| Example 2 | 500 | 5 | 220 |
| Example 3 | 30 | 2 | 180 |
| Example 4 | 100 | 2 | 200 |
| Example 5 | 150 | 3 | 230 |

1 A flexible foam expanding in a fire and based on styrene/butadiene, polyvinyl alcohol, polyurethane or neoprene, wherein said foam contains, as an intumescent component, a combination of phosphoric acid compound, polyalcohol and polyamide.

2 The polyurethane-based flexible foam expanding in a fire, as claimed in claim 1, wherein said foam contains, as polyol component (A), a polyol from the group consisting of polyethylene glycol, polypropylene glycols, polypropylene glycols having ethylene oxide terminal groups, polyesterpolyols, polybutadienes having OH terminal groups, phosphoric ester-based polyols or halogenated polyetherpolyols, and, as polyisocyanate component (B), polyisocyanates from the group consisting of the methylenediphenyl diisocyanates, toluene diisocyanates, modified methylenediphenyl diisocyanates and toluene diisocyanates, prepolymers of methylenediphenyl diisocyanates and toluene diisocyanates, 4,4′-diisocyanatodicyclohexylmethane, isophorone diisocyanate, hexamethylene diisocyanate, 2,2,4(2,4,4)-trimethylhexamethylene diisocyanate, hydrogenated toluene diisocyanate, dimeryl diisocyanate, lysine diisocyanate, trans-1,4-cyclohexane diisocyanate, 1,4-bisisocyanatomethylcyclohexane, benzenedisulfonyl isocyanate, dibenzoyl isocyanate, dihexylane [sic] diisocyanate, 3,3′-dimethyl-4,4′-diisocyanatodicyclohexylmethane, tetramethylene diisocyanate, 2-methylpentamethylene diisocyanate and xylylene diisocyanate, the ratio of component A to component B being from 100:30 to 100:80.

3 The foam expanding in a fire and based on styrene/butadiene, polyvinyl alcohol, polyurethane or neoprene, as claimed in claim 1, wherein phosphoric ester polyols, ammonium polyphosphate, melamine phosphate, ethylenediamine phosphate, ammonium dihydrogen phosphate, aluminum orthophosphate, piperazine phosphate, guanidine phosphate or urea phosphate is or are used as the phosphoric acid compound.

4 The polyurethane-based flexible foam expanding in a fire, as claimed in claim 1, wherein the phosphoric acid compound is a constituent of the polyol component (A) in that polyols based on phosphoric esters are used.

5 The flexible foam expanding in a fire and based on styrene/butadiene, polyvinyl alcohol, polyurethane or neoprene, as claimed in claim 1, wherein dipentaerythritol, polyethylene glycol, pentaerythritol or phosphoric ester-based polyols is or are used as the polyalcohols.

6 The flexible foam expanding in a fire and based on styrene/butadiene, polyvinyl alcohol, polyurethane or neoprene, as claimed in claim 1, wherein melamine, trishydrazinotriazine or dicyanodiamide is used as the polyamide.

7 The flexible foam expanding in a fire and based on styrene/butadiene, polyvinyl alcohol, polyurethane or neoprene, as claimed in claim 1, wherein the phosphoric acid compound, the polyalcohol and melamine are each used in an amount of from 5 to 50% by weight, the sum of the amounts used being not more than 75% by weight.

8 (Original) The flexible foam expanding in a fire and based on styrene/butadiene, polyvinyl alcohol, polyurethane or neoprene, as claimed in claim 1, wherein said foam contains assistants and additives from the group consisting of emulsifiers, foam stabilizers, drying agents, colored pigments, catalysts and solvents.

9 The flexible foam expanding in a fire and based on styrene/butadiene, polyvinyl alcohol or neoprene, as claimed in claim 1, wherein the foam is applied from one-component spray cans, guns or cartridges.

10 The polyurethane-based flexible foam expanding in a fire, as claimed in claim 1, wherein said foam is applied from two-component spray cans, guns or cartridges in which the polyol component and the polyisocyanate component are present separately up to application so as to inhibit reaction.

11 The flexible foam expanding in a fire and based on styrene/butadiene, polyvinyl alcohol, polyurethane or neoprene, as claimed in claim 9, wherein the foam is applied directly on site into the area to be sealed, where it foams to form a fire barrier.

12 The flexible foam expanding in a fire and based on styrene/butadiene, polyvinyl alcohol, polyurethane or neoprene, as claimed in claim 9, wherein the foam, after emerging from the spray cans, guns or cartridges used, has a density of from 25 to 550 g/l.

13 The flexible foam expanding in a fire and based on styrene/butadiene, polyvinyl alcohol, polyurethane or neoprene, as claimed in claim 1, wherein the expansion factor on foaming in a fire is from 1.5 to 15.

14 A method of forming a hot gas seal or heat-insulating soft barrier which comprises employing a flexible foam expanding in a fire and based on styrene/butadiene, polyvinyl alcohol, polyurethane or neoprene, as claimed in claim 1, therefor.

15 The flexible foam expanding in a fire and based on styrene/butadiene, polyvinyl alcohol, polyurethane or neoprene, as claimed in claim 10, wherein the foam is applied directly on site into the area to be sealed, where it foams to form a fire barrier.

16 The flexible foam expanding in a fire and based on styrene/butadiene, polyvinyl alcohol, polyurethane or neoprene, as claimed in claim 10, wherein the foam, after emerging from the spray cans, guns or cartridges used, has a density of from 25 to 550 g/l.
